(19) United States
(12) Patent Application Publication
(10) Pub. No.: US 2022/0293997 A1
(43) Pub. Date: Sep. 15, 2022

(54) ALL-SOLID-STATE LITHIUM SECONDARY BATTERY INCLUDING BOTH SIDE COATED ELECTRODES AND METHOD FOR PRODUCING THE SAME

(71) Applicant: KOREA BASIC SCIENCE INSTITUTE, Yuseong-gu (KR)

(72) Inventors: Hae Jin KIM, Yuseong-gu (KR); Won Gi HONG, Yuseong-gu (KR); Jong Pil KIM, Dongnae-gu (KR); In Jun JEON, Andong-si (KR)

(21) Appl. No.: 17/654,728

(22) Filed: Mar. 14, 2022

(30) Foreign Application Priority Data
Mar. 15, 2021 (KR) 10-2021-0033500

(51) Int. Cl. H01M 10/04; H01M 10/0525

(52) U.S. Cl. CPC H01M 10/044; H01M 10/0525; H01M 2004/021

(57) ABSTRACT

The disclosure relates to an all-solid-state lithium secondary battery, comprising a first electrode having a first active material formed on a side; a second electrode having a side facing the first active material and having a second active material formed on both sides; and a third electrode having a side facing the other side of the second electrode and having a third active material formed on a side or both sides, wherein a capacity ratio of a positive electrode to a negative electrode (N/P ratio) of each active material formed on adjacent current collectors is 1.0 to 1.2.

### CROSS-REFERENCE TO RELATED APPLICATION

This application claims the benefit under 35 U.S.C. § 119 of Korean Patent Application No. 10-2021-0033500 filed on Mar. 15, 2021, in the Korean Intellectual Property Office, the entire disclosure of which is incorporated herein by reference for all purposes.

### BACKGROUND

### 1. Field

The following description relates to an all-solid-state lithium secondary battery including both sides coated and method for producing the same. Specifically, the following description relates to an all-solid-state lithium secondary battery and method for producing the same that may increase an energy density per volume and reduce a thickness of electrodes by embodying electrode active materials on both sides of an electrode, and may prevent lithium electrodeposition and over potential by designing a capacity ratio for opposite areas of a positive electrode and negative electrode, which are combined electrodes, to be 1.0 to 1.2 based on an irreversible capacity value.

### 2. Description of Related Art

As electronic, communication, and computer industries are rapidly developed, a camcorder, cell phone, laptop etc. have been remarkable developed, and a high energy density and stable output of a battery are desired as a power source to operate portable electronic devices. A cheaper and simple process is also desired in manufacturing. An all-solid-state lithium secondary battery is the most actively developed and broadly applied to portable electronic devices among batteries.

An all-solid-state lithium secondary battery must include a cathode, an anode, and electrolyte, and it is charged and discharged by an intercalation or deintercalation of lithium cations reversibly to an electrode. In the charging and discharging process, lithium cations form a charge neutrality with electrons that come to the electrode through a current collector and act as a medium to save an electric energy inside the electrode.

A cathode of the all-solid-state lithium secondary battery refers to an electrode in which lithium cations are implanted in a discharging process of the all-solid-state lithium secondary battery. Since a charge moves to a cathode through an external conducting wire with implanting lithium cations, the cathode is reduced in the discharging process. A transition metal oxide is generally included in the cathode of the all-solid-state lithium secondary battery. The transition metal oxide included in the cathode is called a positive electrode active material. The positive electrode active material generally has a repeated, stereoscopic structure.

On the contrary, an anode of the all-solid-state lithium secondary battery refers to an electrode in which lithium cations are deintercalated in the discharging process of the all-solid-state lithium secondary battery. Since a charge escapes through an external conducting wire with the deintercalation of lithium cations, the anode is oxidized in the discharging process. The anode of the all-solid-state lithium secondary battery generally includes lithium metal, carbon material, and non-carbon material, etc. The carbon material, etc. included in the anode is called a negative electrode active material.

In order to maximize a performance of the all-solid-state lithium secondary battery, a negative electrode active material is generally supposed to have the following critical conditions. i) an amount of electricity to save per unit weight should be large, ii) a density of the negative electrode active material per unit volume should be high, and iii) a structural change due to intercalation and deintercalation of lithium ions should be minor. When the structural change is intense, a strain may be accumulated inside the structure according to charging and discharging, and therefore, an irreversible intercalation and deintercalation of lithium ions may be caused.

According to trends of lightweight and miniaturization of portable devices, studies have been progressed to reduce a volume of a secondary battery inside a portable device. Therefore, secondary batteries having an atypical shape such as a step type or curve type are being developed in order to reduce a dead space in an edge or curve of a portable device. However, in a step type secondary battery manufactured with a stack type or stack/folding type electrode assembly, an energy density may not be improved as much as desired, and cycle characteristics and stability may decrease.

Meanwhile, since a currently used all-solid-state lithium secondary battery utilizes an electrolyte having a combustible organic solvent, there may be a serious safety issue in an external impact, etc. Therefore, an additional material should be applied, or a safety device should be implemented to improve a safety apart from a basic structure of a battery cell, which is a demerit. An all-solid-state battery replaces the typical organic electrolyte with a solid electrolyte, and it attracts attentions as a next generation battery to fundamentally solve the safety issue.

The all-solid-state battery may not be exploded or fired and may have a high energy density. Therefore, technical details for optimization and simplification of the battery are being desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, an all-solid-state lithium secondary battery may include a first electrode having a first active material formed on a side; a second electrode having a side facing the first active material and having a second active material formed on both sides; and a third electrode having a side facing the other side of the second electrode and having a third active material formed on a side or both sides; wherein a capacity ratio of a positive electrode to a negative electrode (N/P ratio) of each active material formed on adjacent current collectors is 1.0 to 1.2.

The third active material formed on a side of the third electrode may face the second electrode, but it is not limited thereto.

The third active material may be formed on both sides of the third electrode, wherein a 2n electrode having a side facing the other side of the third electrode and having a second 2n active material formed on a side or both sides is further included, wherein the n is a natural number from 2 to 20, but it is not limited thereto.

The 2n active material formed on a side of the 2n electrode may face a 2n−1 electrode, but it is not limited thereto.

The 2n active material may be formed on both sides of the 2n electrode, wherein a 2n+1 electrode having a side facing the other side of the 2n electrode and having a 2n+1 active material formed on a side or both sides is further included, wherein the n is a natural number from 2 to 20, but it is not limited thereto.

The 2n+1 active material formed on a side of the 2n+1 electrode may face the 2n electrode, but it is not limited thereto.

The all-solid-state lithium secondary battery may be connected in series and parallel, but it is not limited thereto.

Polarities of the 2n−1 active material and the 2n active material may be different from each other, and the n may be a natural number from 1 to 20, but it is not limited thereto.

The N/P ratio may be an N/P ratio consumed by an irreversible reaction based on a combined electrode, but it is not limited thereto.

The N/P ratio may satisfy the below equation 1, but it is not limited thereto.

(A×B)/{(C×D)−(E×B)} [Equation 1]

In the Equation 1, the A is a reversible capacity (mAh/g) of a negative electrode per weight, the B is a loading density (g/cm²) of a negative electrode active material, the ‘C’ is a reversible capacity (mAh/g) of a positive electrode per weight, the D is a loading density (g/cm²) of a positive electrode active material, and the ‘E’ is an irreversible capacity (mAh/g) of a negative electrode per weight, but it is not limited thereto.

A solid electrolyte may be further included, but it is not limited thereto.

Other features and aspects will be apparent from the following detailed description, the drawings, and the claims.

### BRIEF DESCRIPTION OF THE DRAWINGS

FIG. 1 illustrates an all-solid-state lithium secondary battery according to one or more embodiments of the disclosure.

FIG. 2 illustrates an all-solid-state lithium secondary battery with a typical single-side coated.

FIG. 3 illustrates an areal capacitance of a negative electrode and positive electrode of the all-solid-state lithium secondary battery manufactured by one or more embodiments of the disclosure. (a) of FIG. 3 is an areal capacitance of the negative electrode and positive electrode when assembled, (b) of FIG. 3 is an areal capacitance of the negative electrode and positive electrode when activated, and (c) of FIG. 3 is an areal capacitance of the negative electrode and positive electrode after activated.

FIG. 4 illustrates a graph of dQ/dV according to aspects of charging and discharging an all-solid-state lithium secondary battery manufactured by one or more embodiments of the disclosure. (a) of FIG. 4 shows when n/p is 0.75, (b) of FIG. 4 shows when n/p is 1.01, and (c) of FIG. 4 shows when n/p is 1.31.

(a) of FIG. 5 illustrates an aspect of charging and discharging an all-solid-state lithium secondary battery when n/p is 0.75. (b) of FIG. 5 illustrates the aspect when n/p is 1.01, and (c) of FIG. 5 illustrates the aspect when n/p is 1.31.

FIG. 6 illustrates aspects of charging and discharging the all-solid-state lithium secondary battery manufactured by the Embodiment 1.

FIG. 7 illustrates aspects of charging and discharging the all-solid-state lithium secondary battery manufactured by the Comparative Embodiment 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The disclosure relates to an all-solid-state lithium secondary battery to solve the above problems of a typical art. The disclosure may provide an electrode to increase an energy density per volume and to reduce a thickness of the electrode by embodying electrode active materials on both sides of the electrode.

Additionally, the disclosure may prevent an electrodeposition and over potential by designing a capacity ratio of opposite areas of a positive electrode to negative electrode, which are a combined electrode, to be 1.0 to 1.2 based on an irreversible capacity value.

A detailed description for an all-solid-state lithium secondary battery including both sides coated electrodes and method for producing the same is given with attached drawings and embodiments. However, the disclosure is not limited by the drawings and embodiments.

The disclosure may relate to an all-solid-state lithium secondary battery comprising a first electrode having a first active material formed on a side; a second electrode having a side facing the first active material and having a second active material formed on both sides; and a third electrode having a side facing the other side of the second electrode and having a third active material formed on a side or both sides; wherein a capacity ratio of a positive electrode to a negative electrode (N/P ratio) of each active material formed on adjacent current collectors may be 1.0 to 1.2.

The all-solid-state lithium secondary battery of the disclosure may embody electrode active materials on both sides of an electrode, resulting in reducing a thickness of the electrode and increasing an energy density per volume.

Additionally, a lithium electrodeposition and over potential may be prevented by designing a capacity ratio of opposite areas of a positive electrode to negative electrode, which are a combined electrode, to be 1.0 to 1.2 based on an irreversible capacity value.

Further, through an arrangement of electrodes connecting unit cells in series and parallel, a capacity of the all-solid-state lithium secondary battery may increase, and the energy density may be high.

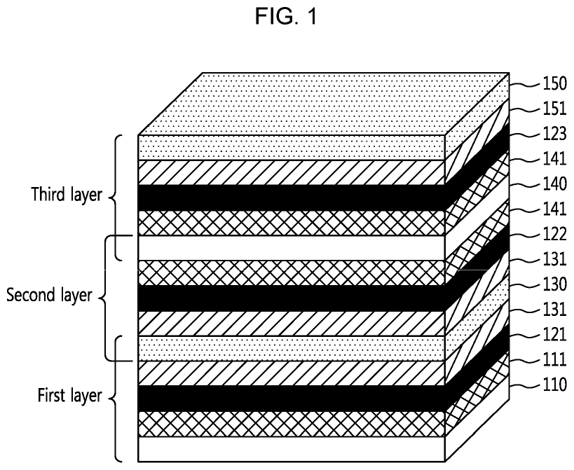

FIG. 1 illustrates an all-solid-state lithium secondary battery according to one or more embodiments of the disclosure.

Specifically, FIG. 1 includes a first electrode 110 having a first active material 111 formed on a side, a second electrode 130 having a side facing the first active material 111 and having a second active material 131 formed on both sides, a third electrode 140 having a side facing the other side of the second electrode 130 and having a third active material 141 formed on both sides, and a fourth electrode 150 facing the other side of the third electrode 140 and having a fourth active material 151 formed on a side. The fourth active material 151 may face the third electrode 140. Additionally, solid electrolyte layers 121, 122, 123 may be interposed between 2n−1 electrodes 110, 140 and 2n electrodes 130, 150. More desirably, the solid electrolyte layer 121 may be interposed between the first active material 111 and the second active material 131. The solid electrolyte layer 122 may be desirably interposed between the second active material 131 and the third active material 141. The solid electrolyte layer 123 may be desirably interposed between the third active material 141 and the fourth active material 151.

The FIG. 1 illustrates an embodiment of an all-solid-state lithium secondary battery of the disclosure with both sides coated, and the disclosure is not limited by the FIG. 1.

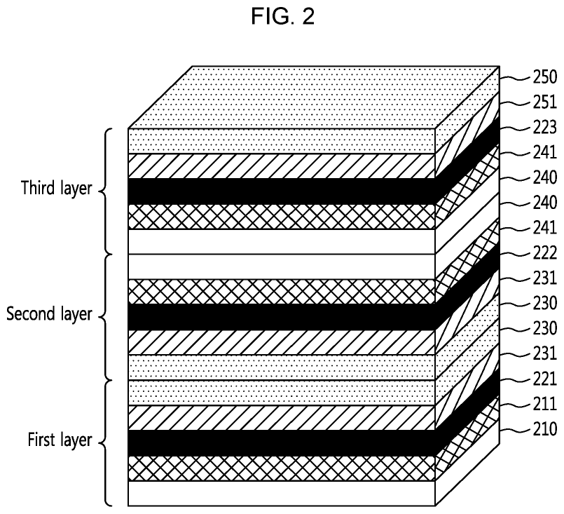

FIG. 2 illustrates an all-solid-state lithium secondary battery with a typical single-side coated.

Specifically, in FIG. 2, a first active material 211 may be formed on a first electrode 210, and a solid electrolyte layer 221 may be formed on the first active material 211. A second active material 231 may be formed on the solid electrolyte layer 221, and a second electrode 230 may be formed on the second active material 231. A second electrode 230 may be formed on the second electrode 230. A second active material 231 may be formed on the second electrode 230, and a solid electrolyte layer 222 may be formed on the second active material 231. A third active material 241 may be formed on the solid electrolyte layer 222, and a third electrode 240 may be formed on the third active material 241. A third electrode 240 may be formed on the third electrode 240. A third active material 241 may be formed on the third electrode 240, and a solid electrolyte layer 223 may be formed on the third active material 241. A fourth active material 251 may be formed on the solid electrolyte layer 223, and a fourth electrode 250 may be formed on the fourth active material 251.

Comparing FIG. 1 with FIG. 2, the volume of FIG. 1 is smaller because the stack height of FIG. 1 is lower. It is because a volume of the entire electrode may be reduced by forming an active material on both sides based on the electrode. On the other hand, with a single-side coated, a current collector between stacked electrodes may be overlappingly stacked, resulting in an increase of volume. Especially, an all-solid-state lithium secondary battery of the disclosure with both sides coated may have a similar or higher capacity compared with an all-solid-state lithium secondary battery with single-side coated. That is, the all-solid-state lithium secondary battery of the disclosure may improve a capacity per volume efficiently.

A solid electrolyte layer may be formed between the 2n−1 active material and the 2n active material.

The third active material formed on a side of the third electrode may face the second electrode, but it is not limited thereto.

The third active material may be formed on both sides of the third electrode. A 2n electrode having a side facing the other side of the third electrode and having a second 2n active material formed on a side or both sides may be further included, and the n may be a natural number from 2 to 20, but it is not limited thereto.

The 2n active material formed on a side of the 2n electrode may face a 2n−1 electrode, but it is not limited thereto.

The 2n active material may be formed on both sides of the 2n electrode. A 2n+1 electrode having a side facing the other side of the 2n electrode and having a 2n+1 active material formed on a side or both sides may be further included, and the n may be a natural number from 2 to 20, but it is not limited thereto.

The 2n+1 active material formed on a side of the 2n+1 electrode may face the 2n electrode, but it is not limited thereto.

In an all-solid-state lithium secondary battery of the disclosure, a 2n−1 electrode, 2n−1 active material, solid electrolyte layer, 2n active material, and 2n electrode may be formed repeatedly and sequentially.

The first electrode and the second electrode may have a sandwich structure with bonded sides, but it is not limited thereto. In an example, the first electrode may be a negative electrode, and the second electrode may be a positive electrode. On the contrary, the first electrode may be a positive electrode, and the second electrode may be a negative electrode. For the first electrode to the 2n+1 electrode, polarities of electrodes facing each other may be opposite.

Polarities of the 2n−1 active material and the 2n active material may be different, and the n may be a natural number from 1 to 20, but it is not limited thereto.

Polarities of the first active material, the third active material, and the 2n+1 active material may be identical, and they may utilize different or identical active material respectively.

Polarities of the second active material, the fourth active material, and the 2n active material may be identical, and they may utilize different or identical active material respectively.

The 2n−1 active material may be a negative electrode active material, and the 2n active material may be a positive electrode active material. On the contrary, the 2n−1 active material may be a positive electrode active material, and the 2n active material may be a negative electrode active material.

The all-solid-state lithium secondary battery may be formed in stack, and each all-solid-state lithium secondary battery may be connected in parallel. The all-solid-state lithium secondary battery may embody a battery with a high capacity because it is connected in parallel.

The all-solid-state lithium secondary battery may be connected in series and parallel, but it is not limited thereto.

Since a plurality of the all-solid-state lithium secondary batteries formed in stack is connected in series, the battery may be operated in a high voltage.

That is, by connected in series and parallel, the all-solid-state lithium secondary battery may embody a high capacity and high energy density with operated in a high voltage simultaneously.

The capacity ratio of a positive electrode to a negative electrode (N/P ratio) may be an N/P ratio consumed by an irreversible reaction based on a combined electrode, but it is not limited thereto.

The positive electrode and the negative electrode may further include an ion conductive material and a lithium salt and form a combined electrode.

The combined electrode may facilitate an internal movement and diffusion of lithium ions by additionally including the ion conductive material and lithium salt.

The ion conductive material may include poly(ethylene glycol) dimethylehter (PEGDME).

A ratio between the ion conductive material and the binder may be 2:1 or 1:2, but it is not limited thereto.

When an amount of the ion conductive material is larger than that of the binder, a conductivity of lithium ions may be improved. When an amount of the binder is larger than that of the ion conductive material, an electrode may be formed more stably.

The lithium salt may include lithium salt selected from a group composing of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloro borane lithium, low-aliphatic series carboxylic acid lithium, 4-phenyl boracic acid lithium and their combinations.

Theoretically, an N/P ratio is 1. When the N/P ratio is below 1, there are lithium inside a cell more than a negative electrode active material may save, and the excessive lithium may cause an electrodeposition or Li plating on a surface of the negative electrode active material. Further, when cycles are repeated, a lithium dendrite may grow, resulting in a short circuit of an all-solid-state lithium secondary battery.

On the contrary, when the N/P ratio is over 1, the lithium electrodeposition may be prevented, but an over potential of a positive electrode active material may occur according to an operating voltage. Therefore, a stability of the positive electrode active material may be deteriorated, and there may be a limitation to embody a high energy density.

Accordingly, by designing the N/P ratio to be close to 1, a stable all-solid-state lithium secondary battery may be embodied, but the ratio may be designed to be approximately 1.1, considering an imbalance of thickness in manufacturing an electrode.

In a typical N/P ratio, an area specific capacity is designed based on a reversible capacity value. On the other hand, in an all-solid-state lithium secondary battery of the disclosure, the ratio may be designed considering an amount of lithium in a positive electrode and an irreversible capacity of a negative electrode consumed by an irreversible reaction. Therefore, the lithium electrodeposition and over potential may be prevented more precisely.

Compared with an all-solid-state lithium secondary battery based on a typical liquid electrolyte, an all-solid-state lithium secondary battery may have a relatively low ion conductivity and different process of forming a SEI layer. Therefore, an initial irreversible capacity may be considered thoroughly when manufacturing an all-solid-state lithium secondary battery. An all-solid-state lithium secondary battery of the disclosure may be designed by considering an irreversible capacity after an activation operation, and therefore, the lithium electrodeposition and over potential may be prevented precisely.

The N/P ratio may satisfy the below equation 1, but it is not limited thereto.

(A×B)/{(C×D)−(E×B)} [Equation 1]

In the Equation 1, the A is a reversible capacity (mAh/g) of a negative electrode per weight, the B is a loading density (g/cm²) of a negative electrode active material, the ‘C’ is a reversible capacity (mAh/g) of a positive electrode per weight, the D is a loading density (g/cm²) of a positive electrode active material, and the ‘E’ is an irreversible capacity (mAh/g) of a negative electrode per weight, but it is not limited thereto.

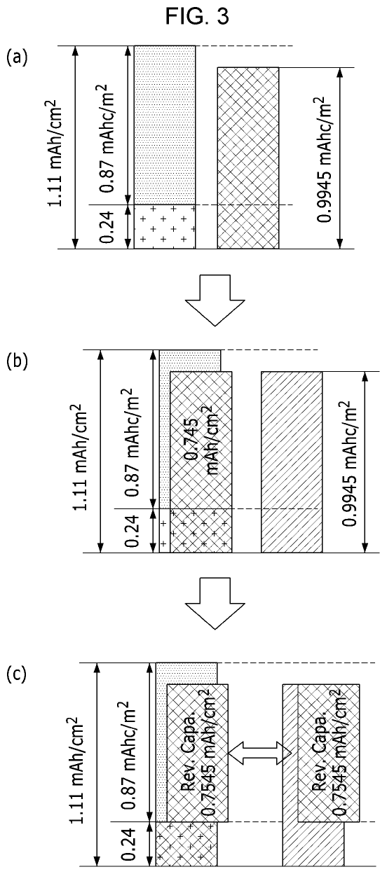

FIG. 3 illustrates an areal capacitance of a negative electrode and positive electrode of the all-solid-state lithium secondary battery manufactured by one or more embodiments of the disclosure. (a) of FIG. 3 is an areal capacitance of the negative electrode and positive electrode when assembled, (b) of FIG. 3 is an areal capacitance of the negative electrode and positive electrode when activated, and (c) of FIG. 3 is an areal capacitance of the negative electrode and positive electrode after activated.

Specifically, the left dots portion of FIG. 3 represents an areal capacitance of the negative electrode, and the right cross stripes portion represents an areal capacitance of the positive electrode.

In FIG. 3, the reversible capacity per weight of the negative electrode is 348 mAh/g, and the loading density of the negative electrode active material is 2.5 mg/cm². The reversible capacity per weight of the positive electrode is 153 mA/g, and the loading density of the positive electrode active material is 6.5 mg/cm′. The irreversible capacity per weight of the negative electrode is 96 mAh/g.

When the capacities of the negative electrode and positive electrode of the all-solid-state lithium secondary battery in FIG. 3 is substituted and calculated in the Equation 1, the N/P ratio is approximately 1.153.

An all-solid-state lithium secondary battery of the disclosure may include a solid electrolyte, but it is not limited thereto.

The solid electrolyte may be interposed between the first active material and the second active material.

The solid electrolyte may be a general solid electrolyte known in the relevant field.

Examples of the solid electrolyte may be organic solid electrolyte such as polyethylene derivatives, polyethylene oxide derivatives, polypropylene oxide derivatives, phosphate ester polymer, poly agitation lysine, polyester sulfide, polyvinyl alcohol, polyvinylindene fluoride, polymer including an ionic dissociator, etc. Additionally, examples of the solid electrolyte may be inorganic solid electrolyte such as Li nitride, halide, or sulplhate of Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, etc.

A positive electrode active material may be selected from a group composing of LiFePO₄, LiNi_{0.5}Mn_{1.5}O₄, LiNiCoAlO₂, LiMn₂O₄, LiCoO₂, LiNiCoMnO₂, lithium nickel cobalt manganese aluminum, and their combinations, but it is not limited thereto.

The positive electrode active material may utilize or manufacture a common cathode known in relevant fields. In one example, after a slurry is manufactured by mixing and stirring a solvent, binder, conductive agent, and dispersant into a positive electrode active material, the positive electrode active material may be formed by coating the slurry to a current collector of metal material, pressing and drying it.

The current collector of metal material may be a metal with a high conductivity, to which the slurry of the positive electrode active material may be easily attached. When a metal has a high conductivity with not causing a chemical change of a battery in a voltage range of the battery, it is not limited by a specific metal. In one example, a stainless steel, aluminum, nickel, titanium, baked carbon, or a surface of aluminum or stainless steel processed by carbon, nickel, titanium, or silver, etc. may be used. Additionally, a slight bump may be formed on a surface of the current collector to enhance an adhesion of the positive electrode active material. The current collector may be a film, sheet, foil, net, porous material, foam, or non-woven fabric material, etc., and its thickness may be adjusted according to a usage.

The positive electrode active material may be a compound substituted by a layered compound such as lithium cobalt oxide [LiₓCoO₂(0.5<x<1.3)], lithium nickel oxide [LiₓNiO₂(0.5<x<1.3)], etc. or additional transition metal; lithium manganese oxide of the chemical formula Li₁₊ₓMn₂₋ₓO₄ (herein, x is 0 to 0.33), LiMnO₃, LiMn₂O₃, or [LiₓMnO₂(0.5<x<1.3)]; lithium copper oxide (Li₂CuO₂); vanadium oxide of LiV₃O₈, LiFe₃O₄, V₂O₅, or Cu₂V₂O₇, etc.; Ni-site type lithium nickel oxide represented by the chemical formula LiNi₁₋ₓMₓO₂ (herein, M=Co, Mn, Al, Cu, Fe, Mg, B or Ga, and x=0.01 to 0.3); lithium manganese complex oxide represented by the chemical formula LiMn₂₋ₓMₓO₂ (herein, M=Co, Ni, Fe, Cr, Zn or Ta, and x=0.01 to 0.1) or Li₂Mn₃MO₈ (herein, M=Fe, Co, Ni, Cu or Zn); LiMn₂O₄ in which some of Li in the chemical formula is substituted by alkali earth metal ion; disulfide compound; Fe₂(MoO₄)₃, etc. An example of the layered compound of lithium cobalt oxide [LixCoO₂(0.5<x<1.3)] or lithium nickel oxide [LiₓNiO₂(0.5<x<1.3)] substituted by additional transition metal may be lithium-manganese-cobalt oxide.

The solvent to form the positive electrode active material may be an organic solvent such as N-methyl pyrrolidone (NMP), dimethyl formamide (DMF), acetone, dimethyl acetamide, etc. or water. The solvent may be used solely or mixed with 2 or more materials. An amount of the used solvent may be determined by considering a coating thickness of the slurry and manufacturing yield enough to dissolve and disperse the positive electrode active material, binder, and conductive agent.

The binder may be the one among various binder polymers such as a polyvinylidene fluoride-hexafluoropropylene copolymer (PVDF-co-HEP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polyacrylic acid, an ethylene-propylene-diene monomer (EPDM), a sulfonated EPDM, a styrene-butadiene rubber (SBR), a fluorine rubber, polyacrylic acid, and a polymer having hydrogen thereof substituted with Li, Na, and Ca, or various copolymers.

The conductive agent may not be limited particularly when it has conductivity not to cause a chemical change to a battery. In one example, a conductive material such as graphite like natural graphite and artificial graphite; carbon black such as acetylene black, Ketjen black, channel black, furnace black, lamp black, and thermal black; conductive fibers such as carbon fibers and metal fibers; conductive tubes such as carbon nanotubes; metal powder such as fluorocarbon, aluminum, or nickel powder; conductive whiskers such as zinc oxide and potassium titanate; conductive metal oxide such as titanium oxide; or conductive material such as polyphenylene derivatives may be used.

The dispersant may be an aqueous-based dispersant or an organic dispersant such as N-methyl-2-pyrrolidone.

A negative electrode active material may be selected from a group composing of an artificial graphite, natural graphite, graphene, metal oxide, Si, SiOₓ, Li₄Ti₅O₁₂ and their combinations, but it is not limited thereto.

A material used in the negative electrode active material may be a carbon material, lithium metal, silicon, or tin where lithium ions are generally occluded and emitted. A carbon material may be desirable, and low-crystalline carbon and high-crystalline carbon may be used all for the carbon material. Representative low-crystalline carbons are soft carbon and hard carbon. Representative high-crystalline carbons are high-temperature baked carbons such as natural graphite, kish graphite, pyrolytic carbon, mesophase pitch based carbon fiber, meso-carbon microbeads, mesophase pitches petroleum or coal tar pitch derived cokes, etc.

A negative current collector may generally have a thickness of 3 μm to 500 μm.

The negative current collector may not be limited particularly when it has conductivity not to cause a chemical change to a battery. In one example, copper, stainless steel, aluminum, nickel, titanium, baked carbon, a surface of copper or stainless steel processed by carbon, nickel, titanium, silver, etc., or aluminum-cadmium alloy may be used. Additionally, like a positive electrode current collector, a slight bump may be formed on a surface to enhance an adhesion of the negative electrode active material, and the current collector may be used as a film, sheet, foil, net, porous material, foam, or non-woven fabric material, etc.

The binder and conductive agent used in the negative electrode active material may be the ones that are generally used in the relevant field, like the positive electrode active material. After a negative electrode active material slurry is manufactured by mixing and stirring the additives and the negative electrode active material, the negative electrode active material may be formed by coating the slurry to the current collector, pressing and drying it.

The solid electrolyte may further include a lithium salt, initiator, cross-liking agent, plasticizer, and additive, etc.

The initiator may harden the polymer electrolyte.

The cross-liking agent may include diacrylate or triacrylate.

The plasticizer may be a compound based on ethylene glycol and may include a material selected from a group composing of PEG (Poly ethylene glycol), PEGME (poly(ethylene glycol)monomethylether), PEGDME (poly(ethylene glycol) Dimethylether), TEG (tetraethylene glycol), TEGDME (tetraethylene glycol dimethyl Ether), Tetraglyme, EC (ethylene carbonate), PC (propylene carbonate), DMP (dimethyl Phthalate), DEP (diethyl phthalate), DBP (dibutyl phthalate), DOP (dioctyl Phthalate), CP (cyclic phosphate) and their combinations.

The all-solid-state lithium secondary battery may further include an additive to improve charging/discharging characteristics or flame retardance, etc. In one example, pyridine, triethylphosphate, triethanolamine, cyclic ether, ethylene diamine, n-glyme, hexaphosphoric triamide, nitrobenzene derivative, sulfur, quinone imine dye, N-substituted oxazolidinone, N, N-substituted imidazolidine, ethylene glycol dialkyl ether, ammonium salt, pyrrole, 2-methoxyethanol, or aluminum trichloride may be further added. In some cases, a solvent having halogen such as carbon tetrachloride, ethylene trifluoride etc. may be further included to give a non-inflammability. Carbon dioxide gas may be further included to improve high-temperature storage characteristics, and FEC(Fluoro-Ethylene carbonate), PRS(Propenesultone), FEC(Fluoro-Ethlene carbonate) may be further included.

In a typical secondary battery, a sharp object such as a nail or drill may penetrate a battery case and invade a positive electrode active material and a negative electrode active material coated by an active material. When a battery is pressed by a tool such as a nipper, a lot of current may flow momentarily into the positive electrode active material and the negative electrode active material and cause internal short circuits of the positive electrode active material and negative electrode active material simultaneously, resulting in a heat. In a worse case, a battery may be exploded or fired. However, an all-solid-state lithium secondary battery of the disclosure may not be exploded and stably activated even when it is cut by scissors.

Since the all-solid-state lithium secondary battery has improved charging characteristics, cycle characteristics and high rate, it may be used for a power source of various electronic devices. Examples of the electronic devices are air conditioner, washing machine, TV, refrigerator, freezer, cooler, laptop, tablet, smartphone, PC keyboard, PC display, desktop, CRT monitor, printer, all-in-one PC, mouse, hard disk, peripherals, iron, clothes dryer, window fan, transceiver, fan, ventilation fan, TV, music recorder, music player, oven, microwave, toilet with cleaning function, hot air heater, car component, vehicle navigation system, flashlight, humidifier, portable karaoke machine, ventilation fan, dryer, air purifier, mobile phone, emergency light, game machine, blood pressure monitor, coffee grinder, coffee maker, kotatsu, copier, disc changer, radio, razor, juicer, shredder, water purifier, lighting fixtures, dehumidifier, dish dryer, rice cooker, stereo, stove, speaker, trouser press, vacuum cleaner, body fat scale, body scale, home bathroom scales, video player, electric blanket, electric rice cooker, electric desk lamp, electric kettle, electronic game console, portable game console, electronic dictionary, electronic organizer, microwave oven, microwave cooker, electronic calculator, electric cart, electric wheelchair, electric tool, electric toothbrush, electric foot heater, hair clipper, telephone, clock, intercom, air circulator, electrocutor, hot plate, toaster, hair dryer, electric drill, hot water heater, panel heater, grinder, soldering iron, video camera, VCR, facsimile, food processor, blanket dryer, headphone, microphone, massager, mixer, sewing machine, rice cake machine, floor heating panel, lantern, remote control, cooler, water cooler, air cooler, word processor, whisk, electronic musical instrument, motorcycle, toy, lawn mower, float, bicycle, automobile, hybrid vehicle, plug-in hybrid vehicle, electric vehicle, railway, ship, airplane, emergency battery, etc.

The disclosure will be described in more detailed way with embodiments below, but the embodiments are merely for description and not intended to restrict the scope of the disclosure.

### Embodiment 1

A slurry is manufactured by mixing lithium iron phosphate 70 wt %, super P 8 wt % as a conductive agent, polyvinylidene fluororide as a binder, polyethylene glycol dimethyl ether and lithium salt 22 wt % as ion conductive materials (binder: ion conductive material are mixed with 1:2 or 2:1) with NMP (N-methyl-2-pyrrolidine). The slurry is coated to both sides of an aluminum foil, dried and rolled, making a positive electrode active material.

A negative electrode active material slurry is manufactured by adding graphite 70 wt % as a negative electrode active material, super-p 8.0 wt % as a conductive agent, polyvinylidene fluororide as a binder, polyethylene glycol dimethyl ether and lithium salt 22 wt % as ion conductive materials (binder: ion conductive material are mixed with 1:2 or 2:1) to a solvent, NMP. The manufactured negative electrode active material slurry is coated to both sides of a copper (Cu) thin film, which is a negative current collector with 10 μm thickness, and dried to make a negative electrode active material. Then, a roll press is performed to make the negative electrode active material.

An electrolyte is manufactured by mixing polyethylene glycol dimethyl ether, lithium salt (LiPF₆), bisphenol A, initiator, and FEC.

The electrolyte is interposed between the positive electrode active material and the negative electrode active material. Subsequently, the electrolyte is hardened to make a solid polymer electrode by pressurizing 1,000 Pa at 90° C. with using a pressure device, manufacturing an all-solid-state lithium secondary battery.

The electrolyte is formed on a cathode coated by the positive electrode active material, and an anode is formed with both sides coated by the negative electrode active material on the electrolyte. The electrolyte is formed on a negative electrode active material formed on the anode, and the cathode is formed with both sides coated by the positive electrode active material on the electrolyte. The process is repeated to manufacture an all-solid-state lithium secondary battery having 5 layers.

### Comparative Embodiment 1

An all-solid-state lithium secondary battery is manufactured by interposing a solid electrolyte between a cathode with single-side coated by the positive electrode active material manufactured by the Embodiment 1 and an anode with single-side coated by the negative electrode active material manufactured by the Embodiment 1.

### [Evaluation]

### 1. Analysis on Characteristics of a Battery

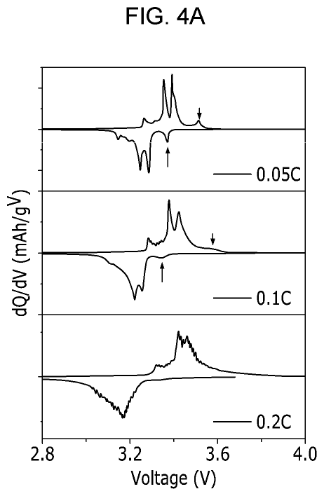

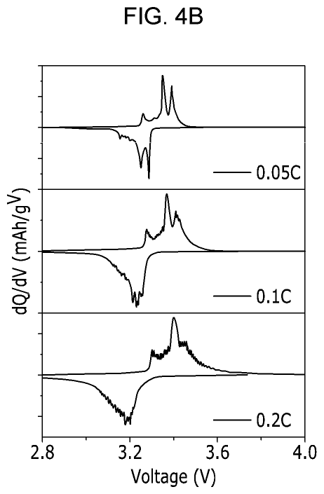

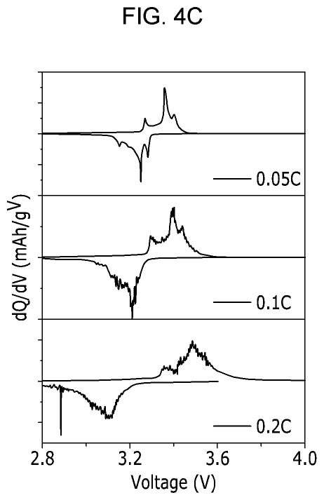

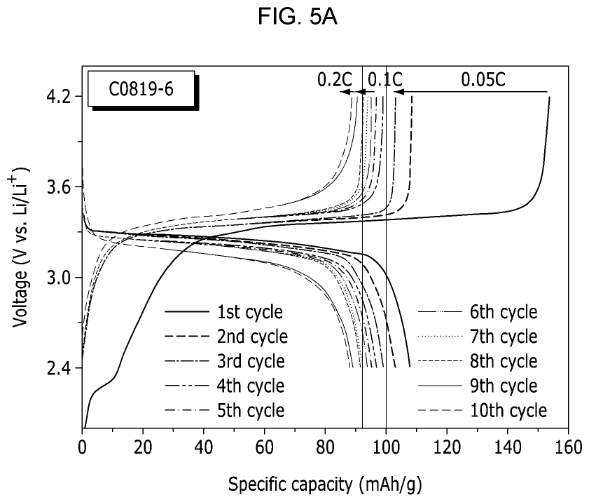

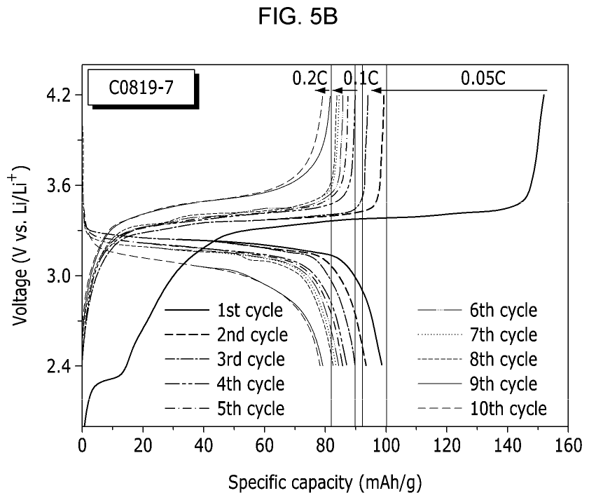

Characteristics of all-solid-state lithium secondary battery of Embodiment 1 and Comparative Embodiment 1 are analyzed, and the results are illustrated in FIG. 4 to FIG. 7.

FIG. 4 illustrates a graph of dQ/dV according to aspects of charging and discharging an all-solid-state lithium secondary battery manufactured by one or more embodiments of the disclosure. (a) of FIG. 4 shows when n/p is 0.75, (b) of FIG. 4 shows when n/p is 1.01, and (c) of FIG. 4 shows when n/p is 1.31.

According to the result shown in FIG. 4, the arrow in (a) of FIG. 4 is a peak due to a lithium electrodeposition. Specifically, the peak is shown by the below reaction formula 1 and 2.

LiFePO₄→Li⁺+e⁻+FePO₄(E^{Li/L+}=3.49 V(charge),3.45 V(discharge)@0.05C) [Reaction Formula 1]

Li⁺+e⁻→Li(E^{Li/Li+}=0 V) [Reaction Formula 2]

In (b) and (c) of FIG. 4, there is no peak due to a lithium electrodeposition.

(a) of FIG. 5 illustrates an aspect of charging and discharging an all-solid-state lithium secondary battery when n/p is 0.75. (b) of FIG. 5 illustrates the aspect when n/p is 1.01, and (c) of FIG. 5 illustrates the aspect when n/p is 1.31.

According to the results shown in FIG. 4 and FIG. 5, when n/p is 1.31, there is no peak due to a lithium electrodeposition in the all-solid-state lithium secondary battery, as illustrated in (c) of FIG. 4. However, the reversible capacity of (c) of FIG. 5 is reduced than the reversible capacity of (b) of FIG. 5, which illustrates the all-solid-state lithium secondary battery when n/p is 1.01.

That is, when an N/P ratio consumed by an irreversible reaction is 1.1 to 1.2, a lithium electrodeposition and over potential may be prevented.

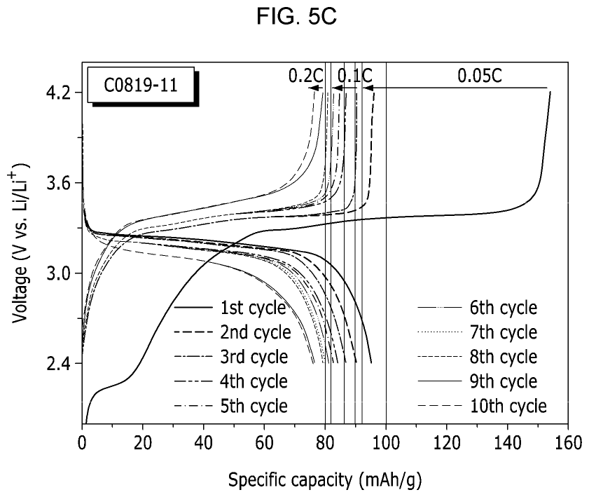

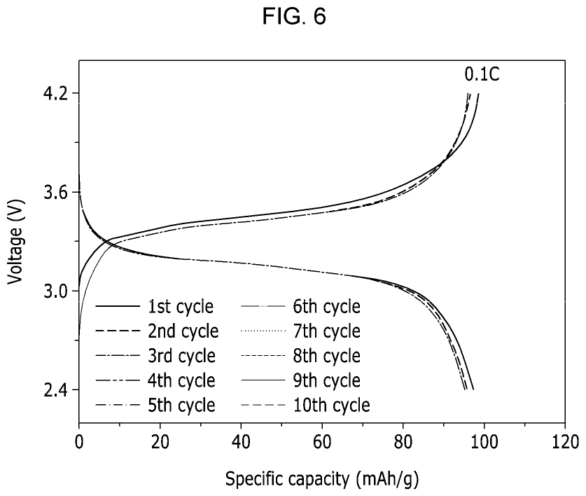

FIG. 6 illustrates aspects of charging and discharging the all-solid-state lithium secondary battery manufactured by the Embodiment 1.

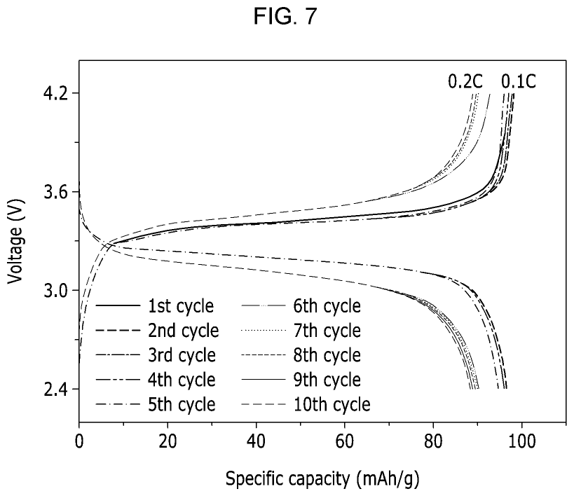

FIG. 7 illustrates aspects of charging and discharging the all-solid-state lithium secondary battery manufactured by the Comparative Embodiment 1.

According to results of FIGS. 6 and 7, the capacity per weight of Embodiment 1 is 95.2 mAh/g, and the capacity per weight of Comparative Embodiment 1 is 88.4 mAh/g. It means that the weight or capacity per volume of the all-solid-state lithium secondary battery manufactured by Embodiment 1 is larger than the capacity of the all-solid-state lithium secondary battery with single-side coated. That is, by embodying electrode active materials on both sides of an electrode, a thickness of a secondary battery may be reduced, and an energy density per volume may increase efficiently.

Further, by embodying electrode active materials on both sides of an electrode, maintaining an N/P ratio to be 1.0 to 1.2, and connecting each all-solid-state lithium secondary battery in series with a parallel structure such as stacking, a synergy may be created.

The disclosed art may have effects as follows. However, it does not mean that a specific embodiment should include all the effects or only the effects, and therefore, the disclosure should not be limited by the below descriptions.

According to the disclosure, an all-solid-state lithium secondary battery of the disclosure may embody electrode active materials on both sides of an electrode, resulting in reducing a thickness of the electrode and increasing an energy density per volume.

Additionally, by designing a capacity ratio for opposite areas of a positive electrode to negative electrode, which are combined electrodes, to be 1.0 or 1.2 based on an irreversible capacity value, a lithium electrodeposition and over potential may be prevented.

Further, through an arrangement of an electrode where unit cells are connected in series and parallel, a high capacity and energy density of an all-solid-state lithium secondary battery may be embodied.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An all-solid-state lithium secondary battery, comprising:
a first electrode having a first active material formed on a side;
a second electrode having a side facing the first active material and having a second active material formed on both sides; and
a third electrode having a side facing the other side of the second electrode and having a third active material formed on a side or both sides,
wherein a capacity ratio of a positive electrode to a negative electrode (N/P ratio) of each active material formed on adjacent current collectors is 1.0 to 1.2.

2. The all-solid-state lithium secondary battery of claim 1,
wherein the third active material formed on a side of the third electrode faces the second electrode.

3. The all-solid-state lithium secondary battery of claim 1,
wherein the third active material is formed on both sides of the third electrode,
wherein a 2n electrode having a side facing the other side of the third electrode and having a second 2n active material formed on a side or both sides is further included,
wherein the n is a natural number from 2 to 20.

4. The all-solid-state lithium secondary battery of claim 3,
wherein the 2n active material formed on a side of the 2n electrode faces a 2n−1 electrode.

5. The all-solid-state lithium secondary battery of claim 3,
wherein the 2n active material is formed on both sides of the 2n electrode,
wherein a 2n+1 electrode having a side facing the other side of the 2n electrode and having a 2n+1 active material formed on a side or both sides is further included,
wherein the n is a natural number from 2 to 20.

6. The all-solid-state lithium secondary battery of claim 5,
wherein the 2n+1 active material formed on a side of the 2n+1 electrode faces the 2n electrode.

7. The all-solid-state lithium secondary battery of claim 1,
wherein the all-solid-state lithium secondary battery is connected in series and parallel.

8. The all-solid-state lithium secondary battery of claim 1,
wherein polarities of the 2n−1 active material and the 2n active material are different from each other,
wherein the n is a natural number from 1 to 20.

9. The all-solid-state lithium secondary battery of claim 1,
wherein the N/P ratio is an N/P ratio consumed by an irreversible reaction based on a combined electrode.

10. The all-solid-state lithium secondary battery of claim 1,
wherein the N/P ratio satisfies the below equation 1:
(A×B)/{(C×D)−(E×B)} [Equation 1]
wherein in the Equation 1,
the A is a reversible capacity (mAh/g) of a negative electrode per weight,
the B is a loading density (g/cm²) of a negative electrode active material,
the ‘C’ is a reversible capacity (mAh/g) of a positive electrode per weight,
the D is a loading density (g/cm²) of a positive electrode active material, and
the ‘E’ is an irreversible capacity (mAh/g) of a negative electrode per weight.

11. The all-solid-state lithium secondary battery of claim 1, comprising:
a solid electrolyte.
